(19) United States
(12) Patent Application Publication
(10) Pub. No.: US 2025/0012623 A1
(43) Pub. Date: Jan. 9, 2025

(54) WEIGHING APPARATUS AND WEIGHT MAGAZINE THEREFOR

(71) Applicant: SARTORIUS LAB INSTRUMENTS GMBH & CO. KG, Goettingen (DE)

(72) Inventors: Sigo MUEHLICH, Bovenden (DE); Lukas NOBACH, Goettingen (DE)

(21) Appl. No.: 18/888,755

(22) Filed: Sep. 18, 2024

Related U.S. Application Data
(63) Continuation of application No. PCT/EP2023/056632, filed on Mar. 15, 2023.

(30) Foreign Application Priority Data
Mar. 29, 2022 (DE) 10 2022 107 331.9

(51) Int. Cl. G01G 21/28

(52) U.S. Cl. CPC G01G 21/28

(57) ABSTRACT

A weighing apparatus (10) includes a weighing sensor, a load carrier (122) and a weighing system coupling the load carrier to the weighing sensor, a weight magazine (14) with a plurality of weights (28) stored therein and a transfer device configured to place the weights on the load carrier as required. The weight magazine is a magazine housing (141) with a magazine door (142) pivotably mounted thereon. The magazine door holds the weights on an interior side thereof, is configured to close the magazine housing, and forms a horizontally elongated weight support which is configured to pivot about a vertical pivot axis over the load carrier. The weights are held on the weight support to be displaced linearly and together in the elongation direction of the weight support and to be displaced linearly individually and vertically between a weight storage position and a weight weighing position.

### CROSS-REFERENCE TO RELATED APPLICATION

This is a Continuation of International Application PCT/EP2023/056632, which has an international filing date of Mar. 15, 2023, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 10 2022 107 331.9 filed on Mar. 29, 2022.

### FIELD OF THE INVENTION

The invention relates to a weighing device comprising
a weighing sensor, a weighing goods carrier and a weighing system coupling the weighing goods carrier to the weighing sensor,
a weight magazine with a plurality of weight pieces stored therein, and
a transfer device configured to place the weight pieces on the weighing goods carrier.

The invention further relates to a weight magazine comprising a plurality of weight pieces commonly movable in a horizontal direction.

Finally, the invention relates to a weight magazine comprising a plurality of weight piece receptacles commonly movable in a horizontal direction.

### BACKGROUND

Such a weighing device and such weight magazines are known from DE 103 00 625 B3.

Weighing devices according to the invention are used for the automated execution of weighing processes in which the weight values of different weight pieces are determined in succession. For this purpose, such weighing devices comprise an actual balance for carrying out the actual weighing process, a weight magazine for storing the weight pieces to be weighed and a transfer device with which the weight pieces can be fed one after the other to the balance or to the weighing process. The actual balance consists of a weighing sensor, which in modern laboratory balances typically operates according to the principle of electromagnetic compensation, a weighing goods carrier, for example a weighing pan, for holding the weight pieces to be weighed during the weighing process and a lever mechanism, referred to here as a weighing system, which couples the weighing goods carrier to the weighing sensor in a displacement- or force-translated manner. Such balances are generally known and are offered for different applications in different configurations and with different precision. The present invention relates primarily to so-called laboratory balances, but can also be used with other types of balances.

DE 10 2015 104 693 A1 describes a so-called comparator, i.e. a balance that is specially designed to compare nominally identical weight pieces with each other with very high precision. Comparators of this type are used, for example, to check calibration weight pieces which are then used to calibrate balance of lower precision classes, such as laboratory balance. For reasons of both economy and reproducibility of such precision measurements, it is desirable to automate the weighing process to ensure that the weight pieces to be weighed are changed quickly and at the same time positioned exactly on the weighing platform-typically exactly in the middle to avoid so-called corner load errors. To this end, the aforementioned publication suggests designing the weight magazine as a horizontally aligned turntable arranged above the balance, on which the weight pieces are positioned around its circumference. Each weight rests on a weight carrier, which is grate-like in the previously known design. The weight carrier of the balance has vertically aligned projections corresponding to the grate. The balance as a whole is arranged on a vertically movable lifting table. To transfer a weight piece to the balance, the turntable is rotated until the weight piece to be weighed is positioned exactly in the middle above the weighing goods carrier. The balance is then lifted until the vertically aligned projections of the weighing goods carrier penetrate the grate-like weight piece receptacle from below and lift the weight piece off the turntable so that its weight acts directly on the weighing goods carrier and is transmitted to the weighing sensor via the weighing system.

A similar comparator is known from U.S. Pat. No. 6,784,380 B2, where the balance stands on a fixed base, whereas the turntable is lowered during the transfer process.

A transfer mechanism for weight pieces between a balance and a weight magazine adjacent to it is known from the generic DE 103 00 625 B3 already mentioned above. A horizontally and vertically movable handling device is arranged between the balance and the magazine, on which a pivot arm with self-centring shaped weight pieces receptacles is mounted. The free end of the pivot arm is shaped like a fork and corresponds to grids, as which the weighing goods carrier of the balance and the weight piece receptacles of the magazine are designed.

DE 20 2005 017 255 U1 discloses a transfer mechanism designed as a portal conveyor between a balance and a weight magazine adjacent to it.

WO 2011/138140 A1 describes the transfer of weight pieces between a balance and a weight magazine adjacent to it employing a multi-axis robot arm.

These transfer mechanism concepts are not very practical for laboratory balances. Laboratory balances typically have a so-called draft shield, the walls of which define a weighing chamber that completely surrounds the weighing pan. It is therefore impossible to transfer weight pieces from a weight magazine located above or to the side of the weighing chamber. Within the weighing chamber, even if the weight pieces were to be stored there, there is typically not enough space for the known transfer mechanisms, as the walls of the weighing chamber typically surround the weighing goods carrier quite closely without unnecessary waste of space. Added to this is the poor cleanability of complex mechanisms, which prevents their arrangement within the weighing chamber.

Nevertheless, a mechanism for automatically transferring different weight pieces from a weight magazine to the weighing goods carrier would be desirable also for laboratory balances, especially for carrying out calibration processes. Such calibration processes must be routinely repeated at predetermined intervals to ensure that the laboratory balance operates within the specified tolerances or to adjust internal calibration and correction parameters. For this purpose, different calibration weight pieces, i.e. weight pieces that are traceable to weight pieces of higher precision classes, must be weighed according to a specified calibration protocol in order to be able to compare the actual weighing result with the nominal values of the calibration weight pieces. Such a calibration process is time-consuming and, if carried out manually, requires specially trained personnel. It is not only important to adhere very precisely to the calibration protocol, including sufficient acclimatization of the calibration weight pieces and exact central positioning on the weighing goods carrier; the proper handling of the sensitive and particularly vulnerable calibration weight pieces is also important.

A special calibration weight arrangement is known from DE 10 2018 106 617 A1, which consists of the actual calibration weight (weight pice) and a housing in which the calibration weight, which is designed as a standardized button weight consisting of a head, neck and body, is suspended from a collar. The interior of the housing is designed such that the suspended calibration weight is mechanically completely released from the housing when it is lifted vertically relative to the housing. In particular, the thickened head of the button weight is suspended from the collar, whose diameter is smaller than the head diameter and larger than the neck diameter and whose thickness is less than the height of the constriction defined as the neck between the head and the body of the calibration weight. If such a calibration weight arrangement is placed centered over the weighing pan of a laboratory balance, the bottom of the weight piece comes to rest on the surface of the weighing goods carrier before the lower edge of the downwardly open housing comes to rest on the base of the balance around the weighing goods carrier. As the housing is lowered further, the calibration weight is raised relative to the housing. As soon as the calibration weight is no longer in mechanical contact with its housing, its weight acts directly on the weighing goods carrier so that it can be weighed precisely. With a suitable centering aid, such a calibration weight arrangement can therefore help to solve the problems of exactly centering and protecting the calibration weight during manual calibration procedures. However, the aforementioned publication does not provide an approach for the desirable automation of the calibration process mentioned above.

### SUMMARY

It is an object of the present invention to improve a generic weighing device such that it can be configured as a laboratory balance. It is a further object of the invention to improve a generic weight magazine such that it can be used to automate the calibration of laboratory balances.

The above-mentioned objects are addressed in that the weight magazine is configured as a magazine housing with a magazine door mounted pivotably to the magazine housing wherein the weight pieces are held on the inside of the magazine door and wherein the magazine housing is closeable with the magazine door, wherein the magazine door forms a weight piece receptacle extending longitudinally in a horizontal direction and is swivelable over the weighing goods carrier about a vertical pivot axis, wherein the weight pieces are held on the weight piece receptacle in a linearly displaceable manner, namely commonly in the longitudinal direction of the weight piece receptacle and individually in the vertical direction between a weight piece storage position and a weight piece weighing position.

The above-mentioned second object is addressed by a weight magazine comprising a magazine door, a magazine housing and a plurality of weight pieces commonly movable in a horizontal direction, the weight pieces being held on the inside of the magazine door, which is pivotably mounted about a vertical pivot axis on the magazine housing which is closable with the magazine door, the common horizontal movability of the weight pieces being of a linear nature and the weight pieces also being individually linearly displaceable in a vertical direction between a weight piece storage position and a weight piece weighing position.

The third of the above-mentioned objects is addressed by a weight magazine comprising a magazine door, a magazine housing and a plurality of weight piece receptacles commonly movable in a horizontal direction, the weight piece receptacles being designed as individual suspensions with which weight pieces shaped as button weight pieces can be held on the inside of the magazine door which is mounted pivotably about a vertical pivot axis on the magazine housing being closeable with the magazine door, wherein the common horizontal movability of the weight piece receptacles is of a linear nature and the individual suspensions and the weight pieces, if present, held thereby, are vertically linearly displaceable between a weight piece storage position and a weight piece weighing position.

Particular embodiments are the subject of the dependent claims.

According to one aspect of the invention, a pivot arm is used as an predominant element of the weight magazine instead of a turntable. This pivot arm has a main direction of extension in the horizontal and is mounted so that it can pivot around the vertical. Similar to a crane jib, a circular sector around the pivot axis can be swept. This sweepable circular sector comprises at least one—preferably the approximately central—position above the weighing goods carrier and a position outside the weighing goods carrier. The former is referred to below as the weighing swivel position, the latter as the rest swivel position. In the particularly preferred case in which the pivot axis is located in the region of a corner of the weighing chamber of a laboratory balance, the swivelable weight piece carrier can thus be swiveled between its rest pivot position, in which it is approximately parallel to a weighing chamber wall, and its weighing swivel position, in which it projects approximately centrally above the weighing goods carrier. According to the invention, the weight pieces are mounted on the pivot arm or weight piece carrier such that they can be moved together linearly along the length of the arm. Hereby, when the weight piece carrier or pivot arm is in its weighing swivel position, each of the weight pieces can be positioned exactly above the center of the weighing goods carrier by moving all the weight pieces together along the length of the arm a corresponding distance. According to the invention, it is also provided that each of the weight pieces—at least when it is in the position described above in the center above the weighing goods carrier—can be individually lowered vertically onto the weighing goods carrier. The horizontal rotational and vertical linear movement of the entire weight magazine known from the prior art is thus replaced in the invention by the combination of a pivoting movement of the weight piece carrier with a common horizontal linear movement of the weight pieces and additionally a vertical linear movement of each individual weight piece.

As previously indicated, such a weight piece carrier can be stored in a very space-saving manner within the weighing chamber of a laboratory balance, so that it does not interfere with the everyday operation of the laboratory balance in its rest svivel position, but can be used during calibration procedures to place the weight pieces one after the other on the weighing goods carrier in accordance with a specified calibration protocol. Together with an advantageous motorization of the individual movements and suitable control of the motors, which is explained in more detail below, the calibration process can be automated. In particular, the calibration process can be started automatically at times when the laboratory balance is not required for normal laboratory operation, for example during night-time laboratory rest periods. Sufficient time can also be scheduled to acclimatize the calibration weight pieces in the weighing chamber that are held on the weight piece carrier. The latter applies above all in cases where the weight piece carrier is brought into the weighing chamber specifically for the purpose of calibration and is pivotably stored there. In cases where the laboratory balance is permanently equipped with a weight piece carrier according to the invention together with the calibration weight pieces mounted on it, there is of course no need for separate acclimatization.

According to a further aspect of the invention, it is provided that the weight piece carrier is configured as a magazine door which, together with a magazine housing on which it is pivotably mounted and which can be closed with the magazine door, forms the weight magazine and on the inside of which the weight pieces are held. This means that the sensitive calibration weight pieces are kept protected inside a closed magazine housing. Such a weight magazine can be arranged in direct contact with the weighing chamber surrounding the weighing goods carrier. Thereby, the magazine door, which functions as a weight pieces carrier according to the invention, can be swung into the weighing chamber and, in particular, over the weight carrier.

It is possible for such a weight magazine to be permanently integrated into the laboratory balance, in particular its weighing chamber. For example, the weight magazine can be integrated into the weighing chamber wall or fixed to it. Alternatively, however, it may also be provided that the weight magazine is reversibly fixed in or on a weighing chamber wall, with an electrical and/or electronic interface of the weight magazine contacting a corresponding interface of the weighing chamber wall. In other words, in this embodiment, the weight magazine is designed as a module that can be inserted into the laboratory balance as required. The power and control supply required to control the motors for the individual movements described above, which will be described in more detail below, is provided via corresponding interfaces on the weight magazine module on the one hand and the weighing chamber wall on the other. Such interfaces can be designed as plug/socket systems, for example, which can also be designed for exact positioning of the module within the weighing chamber.

With regard to the motorization of the weight piece carrier according to the invention, i.e. the magazine door, it can be provided that it can be swiveled by a pivot motor, whereby it can be temporarily fixed in its weighing swivel position, in which each of the weight pieces can be positioned centrally above the weighing goods carrier by horizontal linear movement. The temporary fixability is advantageous in order to be able to reliably maintain the weighing swivel position during the lowering process of the weight piece currently being weighed. Several variants are conceivable for technical realization. A predominantly mechanical solution is for the magazine housing to have a mechanical stop against which the magazine door can be pressed by a motor in the weighing swivel position. The weighing swivel position thus corresponds to a maximum opening of the magazine door. Alternatively, the pivot motor can be designed as a stepper motor. This controls the weighing pivot position by rotating the rotor of the stepper motor by a precisely predetermined number of angular steps. Alternatively, a predominantly electronic solution is that the pivot motor is equipped with a rotation encoder. Such motors can be freely programmed, as is known to those skilled in the art, so that they can move to and maintain a predetermined angular position very precisely. A magazine door that can be pivoted with a stepper motor or such a pivot motor with a rotary encoder can also be opened further than the weighing swivel position if required. This is advantageous if it is occasionally necessary to replace the calibration weight pieces stored in the weight magazine, for example for regular checks. In this case, opening the magazine door wide makes it easier to access the weight pieces stored there.

The weight pieces are advantageously suspended from individual suspensions of a rigid weight housing that is open at the bottom and can be moved by motor along the length of the magazine door. In other words, a rigid weight housing is provided which encloses all the weight pieces. This weight housing can be moved as a whole on the weight carrier, i.e. on the magazine door, which ensures that the weight pieces can be moved horizontally and linearly together. In addition, such a weight housing provides an easy-to-handle unit that protects the calibration weight piece set it contains and can be easily replaced together with the calibration weight pieces if necessary. If, for example, the calibration weight pieces need to be checked by an external, certified body, the entire weight housing including the calibration weight pieces can be sent in and temporarily replaced with an identical weight housing. If the weight housing is closed, with the exception of its mandatory open underside, the entire process can take place without unauthorized persons gaining direct access to the sensitive weight pieces.

Within the weight housing, each individual weight piece is assigned an individual suspension. Each of these individual suspensions can be moved linearly and vertically within the weight housing between a lower stop and an upper stop. The stops define a range within which the respective weight piece can be moved vertically together with its individual suspension. It is considered particularly advantageous if each individual suspension is spring-biased against its upper stop. This means that the individual suspension or the weight suspended from it is lowered into the weight weighing position by applying a lowering force against a spring force. A technical implementation of this principle will be explained in more detail below. However, as soon as the lowering force is removed, the individual suspension is pressed back against its upper stop in the weight storage position by the spring preload and the weight suspended from it is raised accordingly.

It is advantageous if each weight piece is suspended in its individual suspension such that it loses all mechanical contact with the weight housing (including the individual suspension itself) when it is raised relative to the individual suspension. When the bottom of the weight piece, while the individual suspension is lowered, hits the surface of the weighing goods carrier and the individual suspension is lowered further, this corresponds to a relative lifting of the weight piece, which thus loses all contact with the weight housing. It rests exclusively on the weighing goods carrier so that its weight force acts entirely on it. In this state, precise weight determination is possible using the weighing sensor.

With regard to the structural design, such an individual suspension can be advantageously realized in that the weight piece is designed as a rotationally symmetrical button weight with a head of a first diameter, a cylindrical body of a second diameter and a neck of a third diameter arranged between the head and the body, the third diameter being smaller than the first and second diameters, wherein each individual suspension has a cavity which is open at the bottom, surrounds the head of the associated weight piece with radial and axial distance and is bounded at the bottom by a radially inwardly projecting collar with a clear width of a fourth diameter which is smaller than the first diameter and larger than the third diameter. Such a design is particularly advantageous, as calibration weight pieces are often designed as standard button weight pieces in accordance with OIML R 111-1: 2004/DIN 8127:2007-11. Such a button weight hangs with its head on the collar, the thickness of which is less than the clear height of the constriction between the head and body of the button weight. Therefore, when the weight is lifted slightly in relation to the collar, it is completely free from its individual suspension. The weight can therefore be transferred from the weight housing to the weighing goods carrier in the manner described above.

In a favorable improvement of this embodiment, the cavity additionally has a lateral opening in the form of a flat channel extending longitudinally transversely to the direction of travel of the weight housing, the clear channel profile of which is larger than the head profile of the associated weight piece and the underside of the channel is provided with a longitudinal slot passing through it, the width of which is greater than the third diameter. This channel can be designed to rise obliquely radially outwards. Such a channel allows the weight pieces to be inserted laterally into the individual suspensions designed in this way. The head of the weight piece is inserted into the open, radially outer end of the channel, with its neck protruding through the slot on the underside of the channel. The body of the button weight is located below the channel. Thereby, the button weight can be pushed along the channel to its end position in the individual suspension. In embodiments with an inclined channel, the button weight slides automatically into its end position and remains there.

As explained above, the weight housing as a whole can be moved horizontally and linearly. In particular, the weight housing can be moved by motor into different weight housing weighing positions, the number of which corresponds to the number of weight pieces and in each of which one of the weight pieces, which then acts as the currently weighable weight, is positioned centrally above the weighing goods carrier, provided that the weight carrier, i.e. the magazine door, is also in its weighing swivel position. These weight housing weighing positions can be approached very precisely and reproducibly, especially for motors with linear encoders. However, it is within the abilities of the skilled person to identify other embodiments for implementing the required positioning of the weight housing.

In order to lower the weight pieces onto the weighing goods carrier, a motorized plunger, for example, is mounted on the weight carrier, i.e. on the magazine door, with which the individual suspension on which the currently weighable weight is suspended can be pressed down. Especially in the embodiments already described above with spring-loaded individual suspensions, such a motor-driven movable plunger can be realized particularly easily. For example, a pin driven by a worm drive can be used, which is positioned above the weight housing exactly at the point on the weight carrier or the magazine door that is positioned exactly centrally above the weighing goods carrier in the weighing swivel position. After transferring the weight housing to its weight housing weighing position, the individual suspension of the currently weighable weight piece is exactly under the plunger and centered above the weighing goods carrier. When the plunger is lowered by motor, the individual suspension is moved downwards against the spring preload. After a certain lowering distance, the bottom of the weight piece that is currently being weighed makes contact with the weighing goods carrier. The weight piece is then in its weight weighing position. Further advancement of the plunger leads to a further lowering of the individual suspension and to a release of the weight piece, which then stands freely on the weighing goods carrier and can be weighed. After the weighing process, the plunger is moved back to its initial position, whereby the spring preload raises the individual suspension again and presses it against its upper stop. At the same time, the weight piece is lifted up again and off the weighing goods carrier and returned to its weight storage position. As soon as the plunger has retracted so far that it is no longer in contact with the individual suspension, the weight housing can be moved to a new weight housing weighing position in which another weight piece acts as the currently weighable weight piece.

In this way, a complex calibration program can be run automatically. The skilled person will understand that this naturally requires suitable control of the weighing sensor and suitable handling and storage of measured values, which must be coordinated with the purely mechanical movement of the weight pieces. The details of this depend heavily on the specific calibration program and are not the subject of the present invention. Following calibration, the weight carrier, i.e. the magazine door, can be pivoted away from the weighing goods carrier again, in particular the housing-like weight magazine can be closed, so that the weight magazine can either be removed as a whole or, if it is permanently integrated into the laboratory balance, does not interfere with the further operation of the laboratory balance.

Further details and advantages of the invention can be seen from the following detailed description and the drawings.

### BRIEF DESCRIPTION OF THE DRAWINGS

These show, in:

FIG. 1: a rough schematic representation of an exemplary embodiment of a weighing device according to the invention in the form of a laboratory balance,

FIG. 2: the laboratory balance of FIG. 1 with the weight magazine removed,

FIG. 3: an exemplary embodiment of a weight magazine according to the invention with the magazine door swiveled open,

FIG. 4: a rear view of the weight magazine in FIG. 3 with the magazine door closed,

FIG. 5: the magazine door of the weight magazine of FIG. 3 in the weighing swivel position with the weight housing in the weight housing retracted position,

FIG. 6: the magazine door of FIG. 5 with the weight housing in a weight housing weighing position with the currently weighable weight piece in the weight piece storage position,

FIG. 7: the magazine door of FIG. 6 with the currently weighable weight piece in the weight piece weighing position,

FIGS. 8A-8C: three detailed drawings of a weight piece and its individual suspension in a first phase (FIG. 8A), a second phase (FIG. 8B) and a third phase (FIG. 8C) of the vertical linear lowering process and

FIGS. 9A and 9B: detailed drawings of a particular embodiment of an individual suspension, in side view (FIG. 9A) and in sectional view (FIG. 9B).

### DETAILED DESCRIPTION

Identical reference signs in the figures indicate identical or analogous elements.

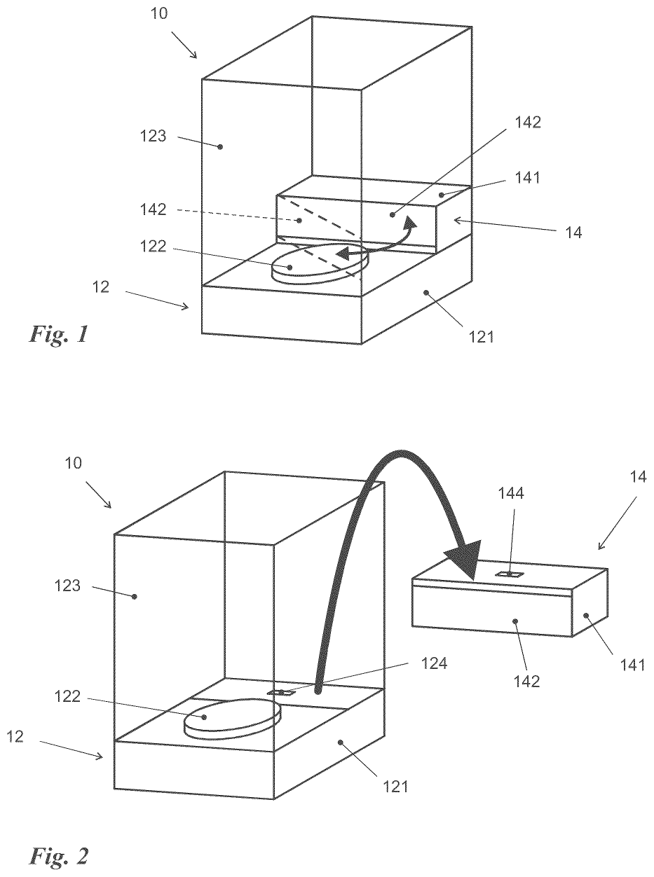

FIG. 1 shows a roughly schematic representation of a weighing device 10 according to the invention, which is designed as a laboratory balance. This comprises an actual balance 12, of which only a balance base body 121, a weighing goods carrier 122 and the weighing chamber walls 123 delimiting the weighing chamber around the weighing goods carrier 122 are shown. Not shown separately are the weighing sensor and the weighing system, which couples the weighing goods carrier 122 with the weighing sensor. These elements, which are not shown, are concealed in the balance base body 121. Typically, this is a weighing sensor operating on the principle of electromagnetic compensation with a corresponding weighing system. However, the special design of this sensor system does not play a role in the present invention.

A weight magazine 14 according to the invention is arranged in the weighing chamber, in particular in the angle between the rear wall of the weighing chamber and the floor of the weighing chamber. It is composed largely of a magazine housing 141 and a magazine door 142. The magazine door 142 is shown with solid lines in a closed state, which is referred to here as the rest swivel position, and with dashed lines in an open state, which is referred to here as the weighing swivel position. In the weighing swivel position, the magazine door 142 projects approximately centrally over the weighing goods carrier 122.

FIG. 2 shows the same weighing device 10 with the weight magazine 14 removed. In the embodiment shown, the weight magazine 14 is designed as a module that can be removably positioned in the weighing chamber. In other embodiments, the weight magazine 14 can also be permanently installed adjacent to the weighing chamber. In the module variant shown, the weight magazine 14 has an electrical and/or electronic interface 144 on its base, which in the inserted state (FIG. 1) contacts a corresponding interface 124 of the weighing chamber base. The weight magazine 14 can be supplied with electrical energy and control signals via this interface pair 124/144.

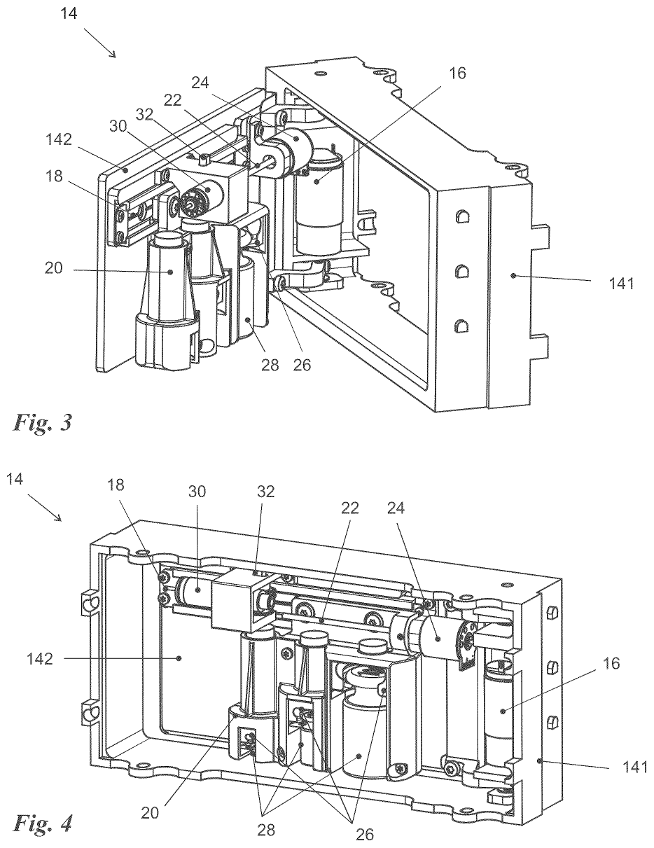

FIGS. 3 and 4 show a particular embodiment of a modular weight magazine 14. The weight magazine 14 is illustrated in FIGS. 3 and 4 without a rear wall opposite the magazine door 142. On the one hand, this serves the purpose of better illustration. On the other hand, actual embodiments without such a rear wall are also possible. In these, the weight magazine 14 is, for example, attached to a rear weighing chamber wall 123 with a suitable locking mechanism, the rear weighing chamber wall 123 then also forming the rear wall of the weight magazine 14. However, embodiments with a closed rear wall of the magazine are also possible.

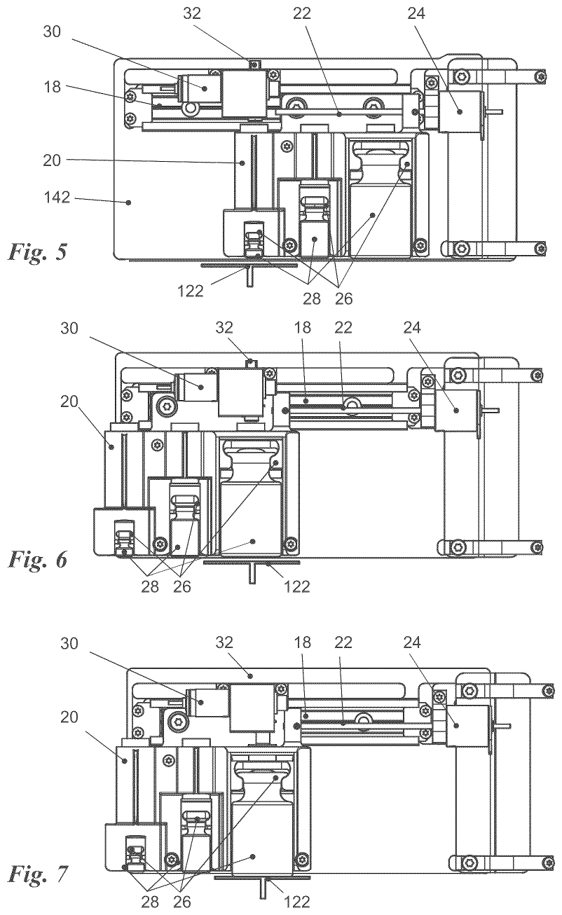

FIG. 3 shows a perspective view of the weight magazine 14 with the magazine door 142 in the weighing swivel position. FIG. 4 shows the same weight magazine 14 with closed magazine door 142 viewed from behind through the open rear wall. FIGS. 5 to 7 show the magazine door 142 in its pivoted weighing position in isolation. These figures will be described together below, unless explicit reference is made to a specific figure.

The magazine door 142 is pivotably hinged to the magazine housing 141 and is provided with a housing-fixed pivot motor 16, which is only shown in FIGS. 3 and 4. With the pivot motor, the magazine door 142 can be swiveled open and closed by a motor, the motor and its control being designed such that precise swivel positions of the magazine door 142 can be approached and maintained, in particular the weighing swivel position shown in FIGS. 5 to 7, which will be discussed in more detail below.

A horizontally aligned rail 18 is fixed to the magazine door 142, on which a weight housing 20 is mounted for linear movement. The weight housing 20 is connected via a spindle drive 22 to a door-mounted sliding motor 24 so that it can be moved by motor along the rail extension. The sliding motor 24 and its control system are for instance designed so that the weight housing 20 can be moved precisely and, in particular, can be moved into various weight housing weighing positions, one of which is shown in FIGS. 6 and 7.

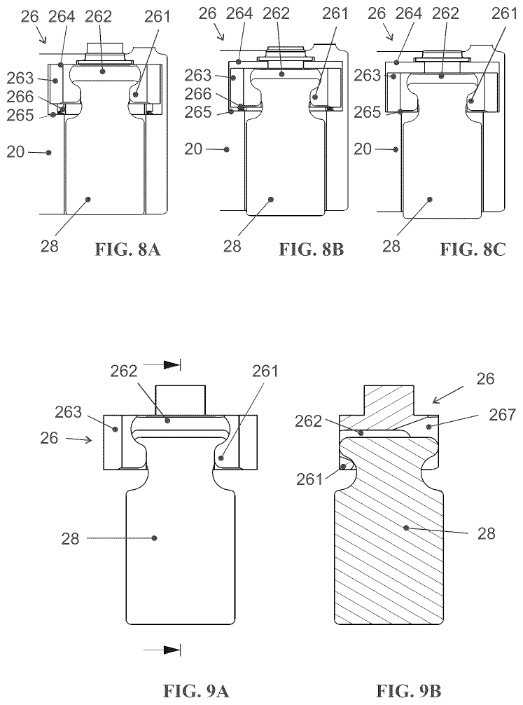

In the embodiment shown, the weight housing 20 comprises a rigid shell which has three separate vertically linearly movable individual suspensions 26 for weight pieces 28. The special design of the individual suspensions 26 will be discussed in more detail below in the context of FIGS. 8A-8C and FIGS. 9A and 9B.

At one position of the magazine door 141, a further motor, the plunger motor 30, is fixed, which is coupled to a plunger 32, for example via a worm drive not shown in detail. The plunger 32 can thus be moved vertically by a motor.

By actuating the slide motor 24, the weight housing 26 can be moved so that, optionally, each of the individual suspensions 26 is positioned exactly below the plunger 32. The plunger 32 is positioned relative to the magazine door 142 so that it is exactly centered above the weighing goods carrier 122 in the weighing swivel position of the magazine door 142 shown in FIGS. 5 to 7.

FIG. 5 shows a weight housing retraction position in which the weight housing is moved as far as possible to the pivot bearing side of the magazine door 142 to relieve the pivot bearing. FIG. 6, on the other hand, shows the weight housing 20 in one of three weight housing weighing positions, in which, in particular, the largest of the weight pieces 28 with its associated individual suspension 26 hovers exactly below the plunger 32 and centrally above the weighing goods carrier 122.

FIG. 7 shows a state in which the plunger 32 is moved downwards by the plunger motor 30 and thereby presses the individual suspension 26 of the largest weight 28 downwards relative to the weight housing 20. In particular, this lowering takes place to such an extent that the base of the weight 28 rests on the surface of the weighing goods carrier 122. The individual suspension 26 is designed such that the weight piece 28 comes free from the individual suspension 26 or from the weight housing 20 and rests solely on the weighing goods carrier 122, so that the weighing sensor coupled to the weighing goods carrier 122 can detect an exact weight value for the weight piece 28.

FIGS. 8A-8C show three phases of such a lowering process. The individual suspension 26 comprises a collar 261, which embraces the neck of the weight 28, which is designed as a standard button weight, with radial and vertical spacing. Its head thus hangs on the collar 261. Above the head of the weight 28, the individual suspension 26 has a free space 262. The collar 261 and the free space 262 are formed by correspondingly shaping a frame 263, which is mounted for vertical linear displacement with a vertical undersize in a corresponding recess in the weight housing 20. In particular, the recess forms an upper abutment 264 and a lower abutment 265 for the frame 263. The frame 263 is spring-biased against the upper abutment 264 by compression springs 266. This situation is illustrated in FIG. 8A.

By lowering the plunger 32, the frame 263 is moved against the spring force of the compression springs 266 in the direction of the lower abutment 265. This lowers the weight piece 28 hanging on the collar 261. This state is shown in FIG. 8B.

The lowering process is started by running the frame 263 against the lower abutment 265, as illustrated in FIG. 8C. During actual operation of the device according to the invention, in particular during the transfer of the weight piece 28 to the weighing goods carrier 122, the bottom of the weight piece 28 strikes the surface of the weighing goods carrier 122 in the lowered position shown in FIG. 8B. During the transition to the lowered position shown in FIG. 8C, the weight 8 cannot continue to follow the downward vertical movement of its individual suspension 26 (unlike that shown in FIG. 8C); instead, it rises relative to the collar 261 so that it comes free of it. Its weight then rests solely on the weighing goods carrier 122.

FIGS. 9A and 9B again show details of the individual suspension 26, namely in side view (FIG. 9A) and in sectional view (FIG. 9B) according to the sectional arrows in FIG. 9A. It can be seen that the collar 261 does not completely surround the neck of the weight piece 28, but merges into a flat, obliquely rising channel 267 on one side. This makes it possible, as can be seen in particular from FIG. 9B, to guide the head of the weight piece 28 into the channel and through it out of the individual suspension 26 by tilting it slightly. The neck of the weight piece 28 passes through a suitably dimensioned slot in the base of the channel 267. The weight piece 28 can be hung in the individual suspension 26 in the opposite way.

The embodiments discussed in the specific description and shown in the figures are only illustrative examples of the present invention. In the light of the present disclosure, the skilled person is provided with a wide range of possible variations.

### LIST OF REFERENCE NUMBERS

10 weighing device
12 balance
121 balance base body
122 weighing goods carrier
123 weighing chamber wall
124 interface
14 weight magazine
141 magazine housing
142 magazine door
144 interface
16 pivot motor
18 rail
20 weight housing
22 spindle drive
24 slide motor
26 individual suspension
261 collar
262 free space
263 frame
264 upper abutment
265 lower abutment
266 compression spring
267 channel
28 weight piece
30 plunger motor
32 plunger

What is claimed is:

1. Weighing device comprising
a weighing sensor, a weighing goods carrier and a weighing system coupling the weighing goods carrier to the weighing sensor,
a weight magazine with a plurality of weight pieces stored therein, and
a transfer device configured to place the weight pieces on the weighing goods carrier, wherein the weight magazine is configured as a magazine housing with a magazine door mounted to pivot with respect to the magazine housing, wherein the weight pieces are held on an interior side of the magazine door and wherein the magazine housing is configured to be closed with the magazine door, wherein the magazine door forms a weight piece receptacle extending longitudinally in a horizontal direction and is arranged and configured to swivel over the weighing goods carrier about a vertical pivot axis, wherein the weight pieces are held in the weight piece receptacle to displace linearly and commonly in the longitudinal direction on the weight piece receptacle, and individually vertically between a weight piece storage position and a weight piece weighing position.

2. Weighing device according to claim 1, wherein the weight magazine is arranged in direct contact with a weighing chamber surrounding the weighing goods carrier.

3. Weighing device according to claim 2, wherein the weight magazine is removeably fixed in or on a weighing chamber wall, and wherein an electrical and/or electronic interface of the weight magazine contacts a corresponding interface of the weighing chamber wall.

4. Weighing device according to claim 1, wherein the magazine door is motorized to pivot via a pivot motor, and wherein the magazine door is configured to be temporarily secured into a weighing swivel position in which the weight pieces are respectively placed, by a horizontal linear movement, centrally above the weighing goods carrier.

5. Weighing device according to claim 4, wherein the magazine housing has a mechanical abutment against which, in the weighing swivel position, the magazine door is motorized to press.

6. Weighing device according to claim 4, wherein the pivot motor comprises a stepper motor.

7. Weighing device according to claim 4, wherein the pivot motor comprises a rotation encoder.

8. Weighing device according to claim 1, wherein the weight pieces are suspended from individual suspensions of a rigid weight housing which is open vertically below and is motorized to move on the magazine door in the longitudinal direction of the magazine door.

9. Weighing device according to claim 8, wherein each individual suspension is mounted to displace vertically linearly between a respective lower abutment and a respective upper abutment.

10. Weighing device according to claim 9, wherein each individual suspension is spring-biased against the respective upper abutment.

11. Weighing device according to claim 8, wherein each of the weight pieces is suspended in a respective one of the individual suspensions such that the respective weight piece loses all mechanical contact with the weight housing when lifted relative to the individual suspension.

12. Weighing device according to claim 11, wherein each of the weight pieces is a rotationally symmetrical button weight with a head of a first diameter, a cylindrical body of a second diameter and a neck of a third diameter arranged between the head and the body, wherein the third diameter is smaller than the first and the second diameters, wherein each individual suspension has a cavity which is open vertically below and surrounds the head of an associated one of the weight pieces with radial and axial oversize and which is bounded vertically below by a radially inwardly projecting collar with a clear width of a fourth diameter which is smaller than the first diameter and is larger than the third diameter.

13. Weighing device according to claim 12, wherein the cavity additionally has a lateral opening formed as a flat channel which extends transversely to a direction of travel of the weight housing and has a clear channel profile that is larger than a head profile of the associated one of the weight pieces and has an underside that is provided with a slot which passes through in the longitudinal direction and has a width that is greater than the third diameter.

14. Weighing device according to claim 13, wherein the channel rises obliquely radially outwards.

15. Weighing device according to claim 8,
wherein the magazine door is motorized to pivot via a pivot motor, and wherein the magazine door is configured to be temporarily secured into a weighing swivel position in which the weight pieces are respectively placed, by a horizontal linear movement, centrally above the weighing goods carrier,
wherein the weight housing is motorized to move into a number of different weight housing weighing positions, wherein the number of different weight housing weighing positions corresponds to the number of weight pieces, and
wherein a given one of the weight pieces which acts as a currently weighable weight piece, is positioned centrally above the weighing goods carrier and the magazine door is contemporaneously in a corresponding one of the weighing swivel positions.

16. Weighing device according to claim 15, further comprising a motor-driven movable plunger mounted on the magazine door and configured to press down the respective individual suspension on which the currently weighable weight is suspended.

17. Weight magazine comprising
a magazine door, a magazine housing and a plurality of weight pieces arranged to move in common in a horizontal direction, wherein the weight pieces are held on an interior side of the magazine door, which is mounted to pivot about a vertical pivot axis on the magazine housing, wherein the magazine housing is configured to be closed with the magazine door, wherein the common horizontal motion of the weight pieces is a linear motion, and wherein the weight pieces are additionally arranged to displace individually and linearly in a vertical direction between a weight piece storage position and a weight piece weighing position.

18. Weight magazine comprising
a magazine door, a magazine housing and a plurality of weight piece receptacles arranged to move in common in a horizontal direction, wherein the weight piece receptacles are configured as individual suspensions configured to hold respective button-shaped weight pieces on an interior side of the magazine door, which is mounted to pivot about a vertical pivot axis on the magazine housing, wherein the magazine housing is configured to be closed with the magazine door, wherein the common horizontal motion of the weight piece receptacles is a linear motion and the individual suspensions and held ones of the weight pieces are arranged to displace vertically and linearly between a weight piece storage position and a weight piece weighing position.
